(19) United States
(12) Patent Application Publication
(10) Pub. No.: US 2014/0031955 A1
(43) Pub. Date: Jan. 30, 2014

(54) CONNECTING DEVICE, SYSTEM AND METHOD FOR SIGNAL TRANSMISSION BETWEEN A CONTROL CENTER AND AT LEAST ONE FIELD DEVICE IN AN INDUSTRIAL INSTALLATION

(71) Applicant: ABB TECHNOLOGY AG, Zurich (CH)

(72) Inventors: Falk RAABE, Birkenau (DE); Jürgen Baumann, Hockenheim (DE); Jörg Orth, Heidelberg (DE); Hubert Kania, Bensheim (DE)

(73) Assignee: ABB TECHNOLOGY AG, Zurich (CH)

(21) Appl. No.: 14/041,410

(22) Filed: Sep. 30, 2013

Related U.S. Application Data
(63) Continuation of application No. PCT/EP2012/055866, filed on Mar. 30, 2012.

(30) Foreign Application Priority Data
Mar. 31, 2011 (EP) 11002673.9

(51) Int. Cl. G05B 15/02

(52) U.S. Cl. CPC G05B 15/02
USPC 700/22

(57) ABSTRACT

A connecting device, system and method for use in an industrial installation is disclosed, which includes at least one first industrial bus interface configured to receive first industrial bus input data and transmit first industrial bus output data using a first industrial bus protocol, and a second industrial bus interface configured to receive second industrial bus input data and transmit second industrial bus output data using a second industrial bus protocol. A modulator is configured to produce first energy bus output data by modulating the first industrial bus input data onto an industrial Ethernet protocol and configured to produce second energy bus output data by modulating the second industrial bus input data onto the industrial Ethernet protocol. An energy communicator is configured to transmit the first and second energy bus output data together as an energy bus output signal on the energy supply line using a carrier frequency method.

### RELATED APPLICATION(S)

This application claims priority as a continuation application under 35 U.S.C. §120 to PCT/EP2012/055866, which was filed as an International Application on Mar. 30, 2012, designating the U.S., and which claims priority to European Application No. 11002673.9 filed in Europe on Mar. 31, 2011. The entire contents of these applications are hereby incorporated herein by reference in their entireties.

### FIELD

The disclosure relates to a connecting device for use in an industrial installation, which device can be connected to an energy supply line and has at least one first industrial bus interface for receiving and/or transmitting first industrial bus input data and/or output data transmitted using a first industrial bus protocol. The disclosure also relates to a system and a method for transmitting signals between a control center and at least one field device in an industrial installation, the system including an energy supply line for supplying the at least one field device with electrical energy.

### BACKGROUND INFORMATION

In modern industrial installations, for example power plants, pumping stations or medium-voltage energy distribution networks of between 3.6 kV and 36 kV, there can be at least one control center which communicates with various so-called field devices, such as sensors, in-situ operating devices, remote operating devices or actuators, for example motors, drives and valves, and in the process transmits data in the form of control commands, for example, and receives status and measurement information. Communication between the control center and field devices can take place via one or more so-called industrial buses, via data cables, in which the information is transmitted using an industrial bus protocol. An industrial bus and the associated industrial bus protocol can be adapted to the environmental conditions of an industrial installation which can be exacerbated in comparison with home or office applications. For example, in the case of industrial bus protocols, a distinction can be made according to the complexity of the bus protocol, for example, between the complex control bus protocols, for example high-speed Ethernet and ControlNet, followed by the so-called field bus protocols, for example Foundation Fieldbus, Profinet and Profibus, in turn followed by the device bus protocols, for example DeviceNet, Profibus DP, SDS and lnterbus-S, and finally the simple sensor buses, for example CAN, ASI and LonWorks.

In addition to being connected to one or more of the data cables needed for bus communication, each field device can also be connected to an energy supply line. In industrial installations, the issue now arises of distances of several tens of meters to several hundred meters usually occurring between the control center and the field devices and of the number of field devices present in such an installation being considerable. Therefore, the cabling of the field devices can use a considerable amount of material but also a considerable amount of planning and installation work.

For example, using energy supply lines not only to transmit energy but also to transmit data at the same time is known, such as, from the fields of home electronics, building automation and the Internet connection of home or office computers. One known method is the so-called power line communication (PLC) standard. In these applications, the data can be modulated onto the current signal of an energy supply line using a carrier frequency method and can then be transmitted together with the current signal. In contrast, only a few attempts to combine data transmission and energy supply lines have previously been known from the field of industrial applications. The article by H. Beikirch and M. Voss, “CAN-transceiver for field bus powerline communications”, IEEE International Symposium on Power Line Communications and its Applications, 2000, pp. 257-264, discusses possibilities of using the sensor bus CAN for communication via the energy supply line. “Applicability of power-line communications to data transfer of on-line condition monitoring of electrical drives” by Jero Ahola, ISBN 951-764-783-2, discloses an application in which sensor data for the online monitoring of electrical drives are transmitted via the energy supply line. Furthermore, there are industrial bus solutions which are available on the market and in which both the data transmission and the supply of field bus devices with energy can be carried out using the same type of line, this line not being a commercially available supply line but rather a two-wire line with or without additional shielding. Such special industrial bus solutions are known, for example, as Profibus-PA or Interbus loop.

### SUMMARY

A connecting device is disclosed for use in an industrial installation, which device can be connected to an energy supply line, the connecting device comprising: at least one first industrial bus interface configured to receive first industrial bus input data transmitted using a first industrial bus protocol; a second industrial bus interface configured to receive second industrial bus input data using a second industrial bus protocol; a modulator configured to produce first energy bus output data by modulating the first industrial bus input data onto an industrial Ethernet protocol and configured to produce second energy bus output data by modulating the second industrial bus input data onto the industrial Ethernet protocol; and an energy communicator configured to transmit the first and second energy bus output data together as an energy bus output signal on the energy supply line using a carrier frequency method.

A connecting device is disclosed for use in an industrial installation, which device can be connected to an energy supply line, the connection device comprising: at least one first industrial bus interface configured to transmit first industrial bus output data using a first industrial bus protocol; a second industrial bus interface configured to transmit second industrial bus output data using a second industrial bus protocol; an energy communicator configured to receive and extract an energy bus input signal which is transmitted via the energy supply line using a carrier frequency method and contains first and second energy bus input data; and a demodulator configured to extract the first and second industrial bus output data modulated onto an industrial Ethernet protocol from the first and second energy bus input data and configured to forward the industrial bus output data to the first and second industrial bus interfaces for output on a respectively associated industrial bus.

A connecting device is disclosed for use in an industrial installation, which device can be connected to an energy supply line, the connecting device comprising: at least one first industrial bus interface configured to receive first industrial bus input data and transmit first industrial bus output data using a first industrial bus protocol; a second industrial bus interface configured to receive second industrial bus input data and transmit second industrial bus output data using a second industrial bus protocol; a modulator configured to produce first energy bus output data by modulating the first industrial bus input data onto an industrial Ethernet protocol and configured to produce second energy bus output data by modulating the second industrial bus input data onto the industrial Ethernet protocol; an energy communicator configured to transmit the first and second energy bus output data together as an energy bus output signal on the energy supply line using a carrier frequency method and configured to receive and extract an energy bus input signal which is transmitted via the energy supply line using the carrier frequency method and contains first and second energy bus input data; and a demodulator configured to extract the first and second industrial bus output data modulated onto the industrial Ethernet protocol from the first and second energy bus input data and configured to forward the industrial bus output data to the first and second industrial bus interfaces for output on a respectively associated industrial bus.

A system is disclosed for transmitting signals between a control center and at least one field device in an industrial installation, the system comprising: an energy supply line configured to supply the at least one field device with electrical energy; a first connecting device, wherein the first connecting device comprises: at least one first industrial bus interface configured to receive first industrial bus input data transmitted using a first industrial bus protocol; a second industrial bus interface configured to receive second industrial bus input data using a second industrial bus protocol; a modulator configured to produce first energy bus output data by modulating the first industrial bus input data onto an industrial Ethernet protocol and configured to produce second energy bus output data by modulating the second industrial bus input data onto the industrial Ethernet protocol; and an energy communicator configured to transmit the first and second energy bus output data together as an energy bus output signal on the energy supply line using a carrier frequency method, and wherein the first connecting device is configured to be connected to the energy supply line and configured to be connected to the control center via at least one first control center industrial bus; and a second connecting device, wherein the second connecting device comprises: at least one first industrial bus interface configured to transmit first industrial bus output data using a first industrial bus protocol; a second industrial bus interface configured to transmit second industrial bus output data using a second industrial bus protocol; an energy communicator configured to receive and extract an energy bus input signal which is transmitted via the energy supply line using a carrier frequency method and contains first and second energy bus input data; and a demodulator configured to extract the first and second industrial bus output data modulated onto an industrial Ethernet protocol from the first and second energy bus input data and configured to forward the industrial bus output data to the first and second industrial bus interfaces for output on a respectively associated industrial bus, and wherein second connecting device is configured to be connected to the energy supply line and configured to be connected to the at least one field device via at least one first field device industrial bus.

A method is disclosed for forward signal transmission between a control center and at least one field device in an industrial installation, the industrial installation comprising an energy supply line configured to supply the at least one field device with electrical energy, the method comprising: receiving a first industrial bus input data transmitted via an associated industrial bus using a first industrial bus protocol; receiving a second industrial bus input data transmitted via an associated industrial bus using a second industrial bus protocol; producing first energy bus output data by modulating the first industrial bus input data onto an industrial Ethernet protocol; producing second energy bus output data by modulating the second industrial bus input data onto the industrial Ethernet protocol; and transmitting the first and second energy bus output data together as an energy bus output signal on the energy supply line using a carrier frequency method.

A method is disclosed for reverse signal transmission between a control center and at least one field device in an industrial installation, the industrial installation comprising an energy supply line configured to supply the at least one field device with electrical energy, the method comprising: transmitting an energy bus input signal via the energy supply line using a carrier frequency method is received and extracted, the energy bus input signal containing first and second energy bus input data; transmitting first industrial bus output data using a first industrial bus protocol obtained from the first energy bus input data by means of extraction from an industrial Ethernet protocol; transmitting second industrial bus output data using a second industrial bus protocol obtained from the second energy bus input data by means of extraction from the industrial Ethernet protocol; and forwarding the industrial bus output data to the first and second industrial bus interfaces for output on a respectively associated industrial bus.

### BRIEF DESCRIPTION OF THE DRAWINGS

The disclosure is explained below with reference to exemplary embodiments shown in the drawings. In the drawings:

FIG. 1 shows an exemplary connecting device for transmitting energy bus output data;

FIG. 2 shows an exemplary connecting device for receiving energy bus input data;

FIG. 3 shows an exemplary connecting device for transmitting energy bus output data and for receiving energy bus input data, respectively, for different industrial bus protocols;

FIG. 4 shows the exemplary connecting device from FIG. 3 which contains two identical industrial bus interfaces;

FIG. 5 shows a diagram of the exemplary layer structure according to the disclosure of data transmission via the energy supply line, and

FIG. 6 shows an example of an exemplary industrial installation.

### DETAILED DESCRIPTION

In accordance with exemplary embodiments, a connecting device, a system and a method is disclosed, which can be used to reduce the amount of cabling needed for field devices in industrial installations by using commercially available energy supply lines to simultaneously transmit data.

In accordance with an exemplary embodiment, a connecting device is disclosed, which can be used as a device for inputting data into an energy supply line and has at least one first industrial bus interface for receiving first industrial bus input data transmitted using a first industrial bus protocol and includes the following elements: modulation means for producing first energy bus output data by modulating the first industrial bus input data onto an industrial Ethernet protocol, and energy communication means for transmitting the first energy bus output data on the energy supply line using a carrier frequency method. In accordance with an exemplary embodiment, the connecting device can be designed as a device for outputting data to an energy supply line and has at least one first industrial bus interface for transmitting first industrial bus output data to be transmitted using the first industrial bus protocol also comprises, according to the disclosure, energy communication means for receiving first energy bus input data modulated onto the industrial Ethernet protocol and transmitted via the energy supply line using the carrier frequency method, and demodulation means for extracting the first energy bus input data from the industrial Ethernet protocol and for producing the first industrial bus output data. The disclosure can also provide a connecting device, which can both input and output data and comprises all of the abovementioned modulation means, demodulation means and energy communication means.

In accordance with an exemplary embodiment, a system is disclosed for transmitting signals between a control center and at least one field device comprises an energy supply line for supplying the at least one field device with electrical energy, a first connecting device which is designed to input or to input and output data, is connected to the energy supply line and is connected to the control center via at least one first control center industrial bus, and a second connecting device which is designed to output or to input and output data, is connected to the energy supply line and is connected to the at least one field device via at least one first field device industrial bus.

In accordance with an exemplary embodiment, a method is disclosed for inputting data into the energy supply line, first industrial bus input data transmitted using the first industrial bus protocol can be received, first energy bus output data can be produced by modulating the first industrial bus input data onto the industrial Ethernet protocol, and the first energy bus output data can be transmitted on the energy supply line using a carrier frequency method. For example, in order to input the data into the energy supply line, the industrial bus input data can therefore not be directly modulated onto the current signal of the energy supply line using a carrier frequency method, as known, but rather an industrial Ethernet transmission level can also be inserted in between.

In accordance with an exemplary embodiment, a method is disclosed for outputting data from the energy supply line comprises the steps of receiving first energy bus input data modulated onto the industrial Ethernet protocol and transmitted via the energy supply line using a carrier frequency method, and extracting the first energy bus input data from the industrial Ethernet protocol, converting said data into first industrial bus output data to be transmitted using the first industrial bus protocol and then transmitting said data via an industrial bus. The associated method steps can take place in parallel with one another and therefore at the same time in a connecting device which can both input and output data.

In accordance with an exemplary embodiment, the connecting devices are not only provided with a first industrial bus interface but can also have a second industrial bus interface which can be used to transmit and receive second industrial bus output data and second industrial bus input data, respectively. For example, in this case, the second industrial bus input data and second industrial bus output data can be transmitted either using the same first industrial bus protocol as the first industrial bus input data and first industrial bus output data or using a second industrial bus protocol which differs therefrom. The number of industrial bus interfaces present and, for example, the number of industrial bus protocols which can be transmitted at the same time can also be extended in any desired manner taking into account the maximum possible data throughput. In accordance with an exemplary embodiment, the number of field devices connected to the respective connecting device can be extended in any desired manner, depending on the type and number of industrial bus interfaces present. For example, communication from and to the control center via the so-called control center industrial bus, provision can be made for the first, second and any further industrial bus protocol to belong to one of the abovementioned more complex protocol types, for example, a control bus protocol or a field bus protocol. For communication from and to the field device via the so-called field device industrial bus, device bus protocols and/or sensor bus protocols as well as proprietary operating device protocols can also be used, depending on the type of field device. In accordance with an exemplary embodiment, the field device can be, for example, an actuator unit, a sensor unit, an in-situ operating device or a remote operating device.

In accordance with an exemplary embodiment, as a result of the use of a plurality of industrial bus interfaces for each connecting device, a combination of an energy and data transmission line is disclosed, which can keep the number of connecting devices to be installed as low as possible, for example when the connecting device is able to process different industrial bus protocols. In accordance with an exemplary embodiment, the use of transmitting different industrial bus protocols using the same energy supply line can allow the entire data communication within the industrial installation to be shifted to the transmission via a supply line, even if there is a multi-bus architecture, without the need to change to the industrial bus protocols and, as a result, can be used to replace field bus devices. For example, the same type of connecting device can be used, which considerably reduces the effort needed for planning, installation and maintenance.

In accordance with an exemplary embodiment, the industrial installation in which the connecting devices according to the disclosure can be used can be, for example, a power plant, a pumping station or an energy distribution system. For example, the spatial distance between the control center and the at least one field device can be between 50 meters and 2 kilometers in such installations. In accordance with an exemplary embodiment, a method according to the power line standard can be used as the carrier frequency method.

In accordance with an exemplary embodiment, a security identifier can be interchanged between the connecting devices before energy bus data are transmitted to help ensure that no external device connected to the energy supply line can illegally read the information converted into energy bus input data and energy bus output data. In accordance with an exemplary embodiment, the connecting device which is ready to receive energy bus input data can be configured to transmit the security identifier, and the connecting device which wishes to transmit the corresponding energy bus output data can be configured to wait until the security identifier has been received by it.

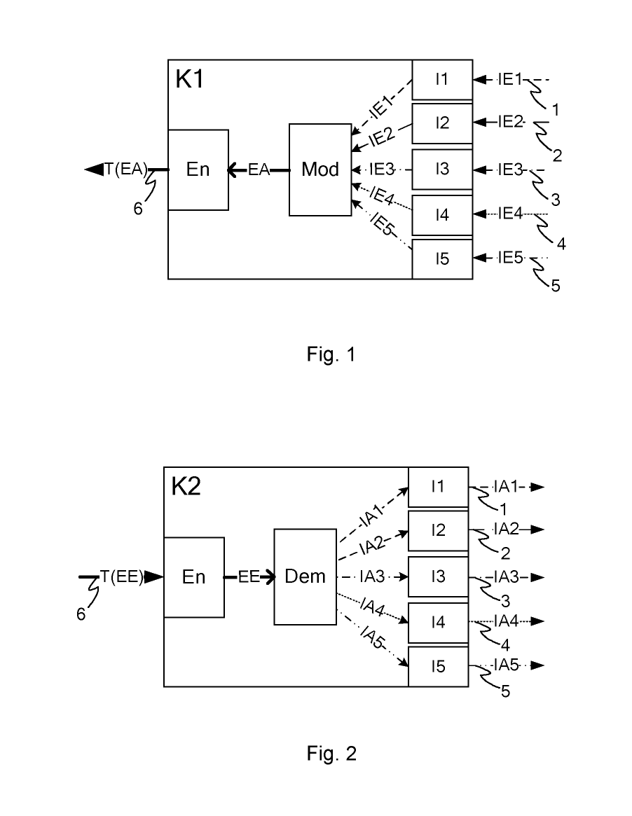

FIG. 1 shows a connecting device K1 having five industrial bus interfaces I1, I2, I3, I4, I5 for receiving associated first to fifth industrial bus input data IE1 to IE5. The first to fifth industrial bus input data IE1 to IE5 are each transmitted via one of the associated industrial buses 1 to 5 using one of five different industrial bus protocols. The diversity of the industrial bus protocols is indicated in the figures by means of the five different types of line of the input arrows. The industrial bus interfaces I1 to I5 forward the respectively received industrial bus input data IE1 to IE5 to modulation means Mod where said data are all modulated onto an industrial Ethernet protocol (IEP). This produces first to fifth energy bus output data EA1 to EA5. The modulation can also be written in simplified form as EA1=Mod(IEP, IE1), EA2=Mod(IEP, IE2) etc. All energy bus output data together result in an energy bus output signal EA={EA1, EA2, EA3, EA4, EA5}. This energy bus output signal EA is forwarded by the modulation means Mod to energy communication means En. The energy communication means En modulate the energy bus output signal EA onto a current signal for transmission on the connected energy supply line 6 using a carrier frequency method T.

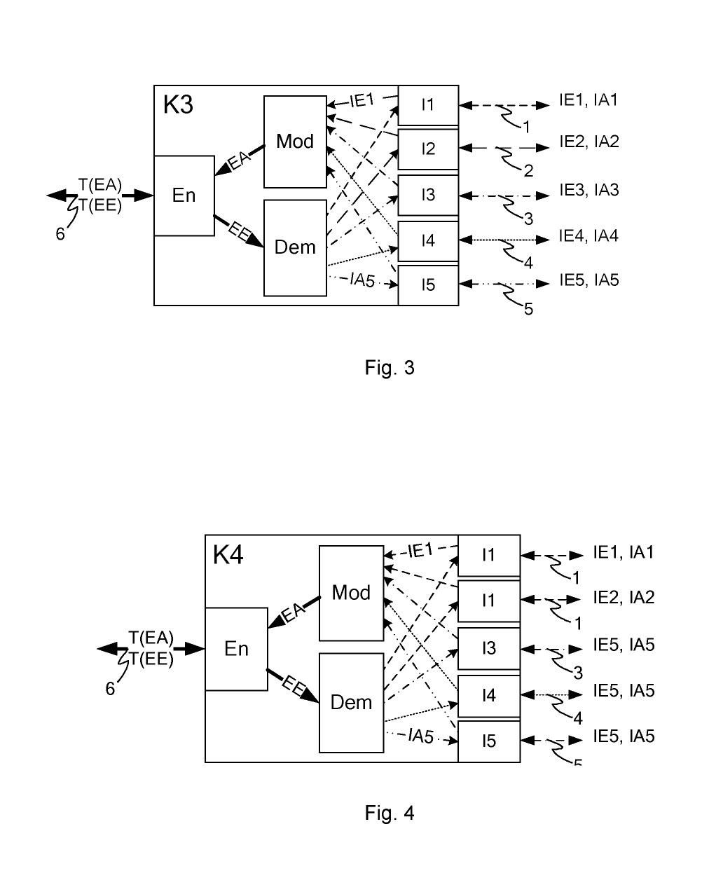

The connecting device K2 illustrated in FIG. 2 has energy communication means En which can be designed to receive and extract an energy bus input signal EE transmitted on the energy supply line 6 using a carrier frequency method T. The energy bus input signal EE contains a total of five different types of energy bus input data EE={EE1, EE2, EE3, EE4, EE5}. Demodulation means Dem extract respectively associated industrial bus output data IA1 to IA5, which have been modulated onto the industrial Ethernet protocol, from the energy bus input signal EE and from the individual energy bus input data EE1 to EE5 and forward the industrial bus output data to respective industrial bus interfaces I1 to I5 for output on the respectively associated industrial bus 1 to 5.

Whereas the connecting device K1 can be provided solely for inputting data from the industrial buses 1 to 5 into the energy supply line 6 and the connecting device K2 can be provided solely for outputting data in the opposite direction, the connecting device K3 from FIG. 3 can be able to do both and therefore can have both the modulation means Mod and the demodulation means Dem. The industrial bus interfaces I1 to I5 and the energy communication means En can each be designed for bidirectional communication. In accordance with an exemplary embodiment, the connecting device K3 can combine the functionalities of the connecting devices K1 and K2.

The connecting device K4 according to FIG. 4 differs from the connecting device K3 only in that the industrial bus interface I1 can be present twice, while there is no industrial bus interface I2. The industrial bus input data IE1 and IE2 and the industrial bus output data IA1 and IA2 can be transmitted using the same industrial bus protocol but can be treated as two input and output data sequences which can each be separate from one another inside the connecting device K4, just like the remaining input and output data.

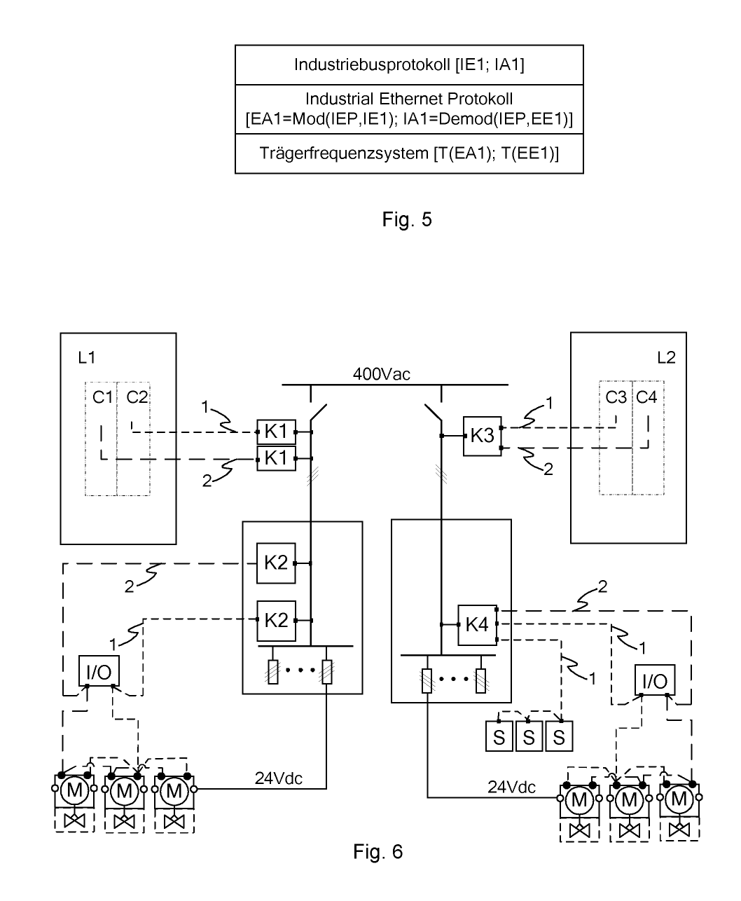

FIG. 5 illustrates the layer structure of the data transmission which takes place via the energy supply line 6. An industrial Ethernet protocol can be placed onto a carrier frequency system and the different industrial bus protocols can be modulated as disclosed above. For example, the type of data to be transmitted can be added between parentheses for each layer.

The industrial installation according to FIG. 6 contains two control centers L1 and L2 which each can communicate with a certain number of field devices, for example, remote operating devices I/O, actuator units consisting of motors M and associated valves, and sensor units S. Communication can be effected using two different industrial buses: a first industrial bus 1, in which the data are transmitted using a field bus protocol, for example Foundation Fieldbus, Profinet or Profibus, and a second industrial bus 2 on which a proprietary operating device protocol can be run. In the control center L1, a first computer unit C1 can be connected to a connecting device of the type K1 via the first industrial bus 1, and a second computer unit C2 can be connected to a further connecting device of the type K1 via the second industrial bus 2. The two connecting devices of the type K1 input the control commands transmitted by the computer units C1 and C2 into a 400 V AC energy supply line in the form of industrial bus input data according to the above-described double modulation using the industrial Ethernet protocol and the carrier frequency method.

On the field-device side, two corresponding connecting devices of the type K2 can be present, which connecting devices output the data input by the connecting devices of the type K1 from the 400 V AC energy supply line again by means of double demodulation and provide associated field devices with said data. For example, the industrial bus output data from the first industrial bus 1 can be transmitted to the motors M of the actuator units and to the remote operating device I/O, and the output data from the second industrial bus 2 can be transmitted to the in-situ operating devices (not illustrated separately) belonging to the motors M of the actuator units and to the remote operating device I/O. For example, only a short distance of a few meters needs to be overcome by the industrial buses 1 and 2 between the control center L1 and the connecting devices of the type K1. The same can be applied to the distance between the connecting devices of the type K2 and the field devices. In contrast, the distance between the K1 and K2 devices can be comparatively long, for example, at several hundred meters. The field devices are supplied not only with data but also with energy via the 400 V AC supply line, which can be indicated by the transformation to a 24 V DC supply line which can be connected to the motors M.

In accordance with an exemplary embodiment, on the side of the second control center L2 and the associated field devices, a bidirectional connecting device of the type K3 can be used for inputting the data into the 400 V energy supply line and a bidirectional connecting device of the type K4 can be used for outputting the data. Accordingly, control commands cannot only be transmitted from the control center to the field devices, but a flow of data in the opposite direction can also be obtained, for example for the purpose of transmitting status and measurement information from the field devices to the control center. In accordance with an exemplary embodiment, sensors S can also be provided below the field devices, which sensors output their data using the field bus protocol and therefore via the first industrial bus 1.

In addition to the exemplary embodiments illustrated in the figures, further exemplary embodiments of the disclosure are conceivable. For example, the connecting devices can convert the industrial bus output data into an industrial bus protocol other than that in which the data were originally received. For example, in accordance with an exemplary embodiment, it is also conceivable to directly operate connecting devices of the type K1 and of the type K2 alongside one another and to connect them to the same industrial bus in order to thus enable bidirectional communication. For example, the number of connecting devices in FIG. 6 can be extended in any desired manner, depending on the number of computer units to be connected to the energy supply line in the control centers or depending on the number of field devices and type of industrial buses to be connected.

Thus, it will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

What is claimed is:

1. A connecting device for use in an industrial installation, which device can be connected to an energy supply line, the connecting device comprising:
at least one first industrial bus interface configured to receive first industrial bus input data transmitted using a first industrial bus protocol;
a second industrial bus interface configured to receive second industrial bus input data using a second industrial bus protocol;
a modulator configured to produce first energy bus output data by modulating the first industrial bus input data onto an industrial Ethernet protocol and configured to produce second energy bus output data by modulating the second industrial bus input data onto the industrial Ethernet protocol; and
an energy communicator configured to transmit the first and second energy bus output data together as an energy bus output signal on the energy supply line using a carrier frequency method.

2. The connecting device as claimed in claim 1, wherein the energy communicator is configured to transmit the first and/or second energy bus output data only when a security identifier of a receiving device connected to the energy supply line is available.

3. A connecting device for use in an industrial installation, which device can be connected to an energy supply line, the connection device comprising:
at least one first industrial bus interface configured to transmit first industrial bus output data using a first industrial bus protocol;
a second industrial bus interface configured to transmit second industrial bus output data using a second industrial bus protocol;
an energy communicator configured to receive and extract an energy bus input signal which is transmitted via the energy supply line using a carrier frequency method and contains first and second energy bus input data; and
a demodulator configured to extract the first and second industrial bus output data modulated onto an industrial Ethernet protocol from the first and second energy bus input data and configured to forward the industrial bus output data to the first and second industrial bus interfaces for output on a respectively associated industrial bus.

4. The connecting device as claimed in claim 3, wherein the energy communicator is configured to transmit a security identifier on the energy supply line.

5. A connecting device for use in an industrial installation, which device can be connected to an energy supply line, the connecting device comprising:
at least one first industrial bus interface configured to receive first industrial bus input data and transmit first industrial bus output data using a first industrial bus protocol;
a second industrial bus interface configured to receive second industrial bus input data and transmit second industrial bus output data using a second industrial bus protocol;
a modulator configured to produce first energy bus output data by modulating the first industrial bus input data onto an industrial Ethernet protocol and configured to produce second energy bus output data by modulating the second industrial bus input data onto the industrial Ethernet protocol;
an energy communicator configured to transmit the first and second energy bus output data together as an energy bus output signal on the energy supply line using a carrier frequency method and configured to receive and extract an energy bus input signal which is transmitted via the energy supply line using the carrier frequency method and contains first and second energy bus input data; and
a demodulator configured to extract the first and second industrial bus output data modulated onto the industrial Ethernet protocol from the first and second energy bus input data and configured to forward the industrial bus output data to the first and second industrial bus interfaces for output on a respectively associated industrial bus.

6. The connecting device as claimed in claim 5, wherein the energy communicator is configured to transmit a security identifier on the energy supply line and to transmit the first and/or second energy bus output data only when a security identifier of a receiving device connected to the energy supply line is available.

7. A system for transmitting signals between a control center and at least one field device in an industrial installation, the system comprising:
an energy supply line configured to supply the at least one field device with electrical energy;
a first connecting device, wherein the first connecting device comprises:
at least one first industrial bus interface configured to receive first industrial bus input data transmitted using a first industrial bus protocol;
a second industrial bus interface configured to receive second industrial bus input data using a second industrial bus protocol;
a modulator configured to produce first energy bus output data by modulating the first industrial bus input data onto an industrial Ethernet protocol and configured to produce second energy bus output data by modulating the second industrial bus input data onto the industrial Ethernet protocol; and
an energy communicator configured to transmit the first and second energy bus output data together as an energy bus output signal on the energy supply line using a carrier frequency method, and wherein the first connecting device is configured to be connected to the energy supply line and configured to be connected to the control center via at least one first control center industrial bus; and
a second connecting device, wherein the second connecting device comprises:
at least one first industrial bus interface configured to transmit first industrial bus output data using a first industrial bus protocol;
a second industrial bus interface configured to transmit second industrial bus output data using a second industrial bus protocol;
an energy communicator configured to receive and extract an energy bus input signal which is transmitted via the energy supply line using a carrier frequency method and contains first and second energy bus input data; and
a demodulator configured to extract the first and second industrial bus output data modulated onto an industrial Ethernet protocol from the first and second energy bus input data and configured to forward the industrial bus output data to the first and second industrial bus interfaces for output on a respectively associated industrial bus, and wherein second connecting device is configured to be connected to the energy supply line and configured to be connected to the at least one field device via at least one first field device industrial bus.

8. The system as claimed in claim 7, comprising:
a second field device which is supplied with electrical energy via the energy supply line, the second connecting device being configured to be connected to the second field device via the at least first field device industrial bus and/or via at least one second field device industrial bus.

9. The system as claimed in claim 8, comprising:
a second connecting device which is configured to be connected to the energy supply line and configured to be connected to the second field device via the at least first field device industrial bus and/or via the at least one second field device industrial bus.

10. The system as claimed in claim 7, wherein the communication on the at least first control center industrial bus and the at least first field device industrial bus is configured to use a same industrial bus protocol.

11. The system as claimed in claim 7, wherein the communication on the at least first control center industrial bus and/or the at least first field device industrial bus and/or the at least one second field device industrial bus is configured to use a control bus protocol or a field bus protocol.

12. The system as claimed in claim 7, wherein the communication on the at least first field device industrial bus and/or the at least one second field device industrial bus is configured to use a device bus protocol, a sensor bus protocol, or an operating device protocol.

13. The system as claimed in claim 7, wherein the first connecting device further comprises:
a demodulator configured to extract the first and second industrial bus output data modulated onto the industrial Ethernet protocol from the first and second energy bus input data and configured to forward the industrial bus output data to the first and second industrial bus interfaces for output on a respectively associated industrial bus.

14. The system as claimed in claim 7, wherein the second connecting device further comprises:
a modulator configured to produce first energy bus output data by modulating the first industrial bus input data onto an industrial Ethernet protocol and configured to produce second energy bus output data by modulating the second industrial bus input data onto the industrial Ethernet protocol.

15. A method for forward signal transmission between a control center and at least one field device in an industrial installation, the industrial installation comprising an energy supply line configured to supply the at least one field device with electrical energy, the method comprising:
receiving a first industrial bus input data transmitted via an associated industrial bus using a first industrial bus protocol;
receiving a second industrial bus input data transmitted via an associated industrial bus using a second industrial bus protocol;
producing first energy bus output data by modulating the first industrial bus input data onto an industrial Ethernet protocol;
producing second energy bus output data by modulating the second industrial bus input data onto the industrial Ethernet protocol; and
transmitting the first and second energy bus output data together as an energy bus output signal on the energy supply line using a carrier frequency method.

16. A method for reverse signal transmission between a control center and at least one field device in an industrial installation, the industrial installation comprising an energy supply line configured to supply the at least one field device with electrical energy, the method comprising:
transmitting an energy bus input signal via the energy supply line using a carrier frequency method is received and extracted, the energy bus input signal containing first and second energy bus input data;
transmitting first industrial bus output data using a first industrial bus protocol obtained from the first energy bus input data by means of extraction from an industrial Ethernet protocol;
transmitting second industrial bus output data using a second industrial bus protocol obtained from the second energy bus input data by means of extraction from the industrial Ethernet protocol; and
forwarding the industrial bus output data to the first and second industrial bus interfaces for output on a respectively associated industrial bus.

17. The method as claimed in claim 16, further comprising:
performing a method for forward signal transmission between the control center and the at least one field device in the industrial installation in parallel with the method for reverse signal transmission, and wherein the method for forward signal transmission comprises:
receiving a first industrial bus input data transmitted via an associated industrial bus using a first industrial bus protocol;
receiving a second industrial bus input data transmitted via an associated industrial bus using a second industrial bus protocol;
producing first energy bus output data by modulating the first industrial bus input data onto an industrial Ethernet protocol;
producing second energy bus output data by modulating the second industrial bus input data onto the industrial Ethernet protocol; and
transmitting the first and second energy bus output data together as an energy bus output signal on the energy supply line using a carrier frequency method.
